(19) United States
(12) Patent Application Publication
(10) Pub. No.: US 2017/0101299 A1
(43) Pub. Date: Apr. 13, 2017

(54) MANEUVERABLE SERVICE DOOR FOR BEVERAGE DISPENSING MACHINES

(71) Applicant: Cornelius, Inc., St. Paul, MN (US)

(72) Inventors: Zachary Dresser, West Chicago, IL (US); Slawomir Kielian, Des Plaines, IL (US)

(73) Assignee: Cornelius, Inc., St. Paul, MN (US)

(21) Appl. No.: 14/964,819

(22) Filed: Dec. 10, 2015

Related U.S. Application Data
(60) Provisional application No. 62/239,463, filed on Oct. 9, 2015.

(51) Int. Cl. B67D 1/06; B67D 1/08

(52) U.S. Cl. CPC B67D 1/06; B67D 1/0888; B67D 1/0891

(57) ABSTRACT

A beverage dispensing machine which defines a service opening through which beverage dispensing equipment is accessible to an operator includes a service door on a housing that is movable between an open position, such that the beverage dispensing equipment is accessible to an operator via the service opening, and a closed position, such that the service door closes the service opening so that the beverage dispensing equipment is inaccessible to the operator. A display panel on the service door displays operational characteristics of the beverage dispensing equipment. When the service door is in the open position the display panel is maneuverable so that the display panel is angled towards the service opening so that an operator can view the display panel while accessing the beverage dispensing equipment via the service opening.

### CROSS-REFERENCE TO RELATED APPLICATION

The present application claims priority U.S. Provisional Patent Application No. 62/239,463, filed on Oct. 9, 2015, the content of which is hereby incorporated herein by reference in its entirety.

### FIELD

The present disclosure relates to apparatuses for beverage dispensing machines, specifically maneuverable service doors for beverage dispensing machines.

### BACKGROUND

The following U.S. patents and patent application are incorporated herein by reference in entirety: U.S. Pat. No. 8,690,016, U.S. Pat. No. 8,893,926, and U.S. patent application Ser. No. 14/696,592 (filed Apr. 27, 2015).

### SUMMARY

This Summary is provided to introduce a selection of concepts that are further described herein below in the Detailed Description. This Summary is not intended to identify key or central features from the claimed subject matter, nor is it intended to be used as an aid in limiting the scope of the claimed subject matter.

In certain examples, a beverage dispensing machine includes a housing that houses beverage dispensing equipment for the beverage dispensing machine. The housing defines a service opening through which the beverage dispensing equipment is accessible to an operator. The beverage dispensing machine includes a service door on the housing that is movable between an open position such that the beverage dispensing equipment is accessible to an operator via the service opening and a closed position such that the service door closes the service opening so that the beverage dispensing equipment is inaccessible to the operator. The service door has an inner side that faces the housing when the service door is in the closed position and the service door has an outer side that faces away from the housing when the service door is in the closed position. A display panel on the outer side of the service door is configured to display an operational characteristic of the beverage dispensing equipment to an operator when the service door is in the closed position and when the service door is in the open position. When the service door is in the open position the display panel is maneuverable so that the display panel is angled towards the service opening so that an operator can view the display panel while accessing the beverage dispensing equipment via the service opening.

In certain examples, a door apparatus for a beverage dispense machine having a housing for housing beverage dispensing equipment of the beverage dispensing machine and defining a service opening through which the beverage dispensing equipment is accessible to an operator includes a service door coupled to the housing and movable between an open position such that the beverage dispensing equipment is accessible to an operator via the service opening and a closed position such that the service door closes the service opening so that the beverage dispensing equipment is inaccessible to the operator. The service door has an inner side that faces the housing when the service door is in the closed position and an outer side that faces away from the housing when the service door is in the closed position. A display panel on the outer side of the service door is configured to display an operational characteristic of the beverage dispensing equipment to an operator when the service door is in the closed position and when the service door is in the open position. When the service door is in the open position the display panel is maneuverable such that the display panel is angled towards the service opening so that an operator can view the display panel while accessing the beverage dispensing equipment via the service opening.

### BRIEF DESCRIPTION OF THE DRAWINGS

Examples of a beverage dispensing machine are described with reference to the following drawing FIGURES. The same numbers are used throughout the FIGURES to reference like features and components.

FIG. 1 is a perspective view of a beverage dispensing machine having a service door in a closed position.

FIG. 2 is a top view of FIG. 1.

FIG. 3 is a perspective view of the service door in a first intermediate position.

FIG. 4 is a top view of FIG. 3.

FIG. 5 is a perspective view of the service door in a second intermediate position.

FIG. 6 is a top view of FIG. 5.

FIG. 7 is a perspective view of the service door in an open position.

FIG. 8 is a top view of FIG. 7.

FIG. 9 is an exploded view of a pivot arm.

FIG. 10 is a side view of the service door moving toward a housing.

FIG. 11 is a side view of the service door moving toward the housing and a first camming surface and a second camming surface contacting each other.

FIG. 12 is a side view of the service door in the closed position.

### DETAILED DESCRIPTION OF THE DRAWINGS

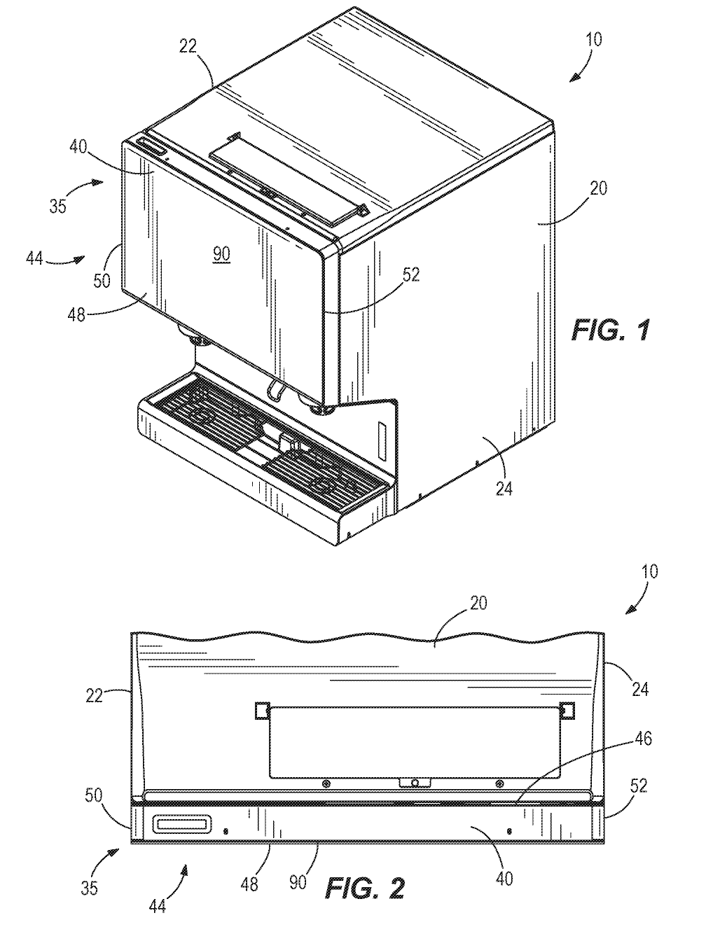

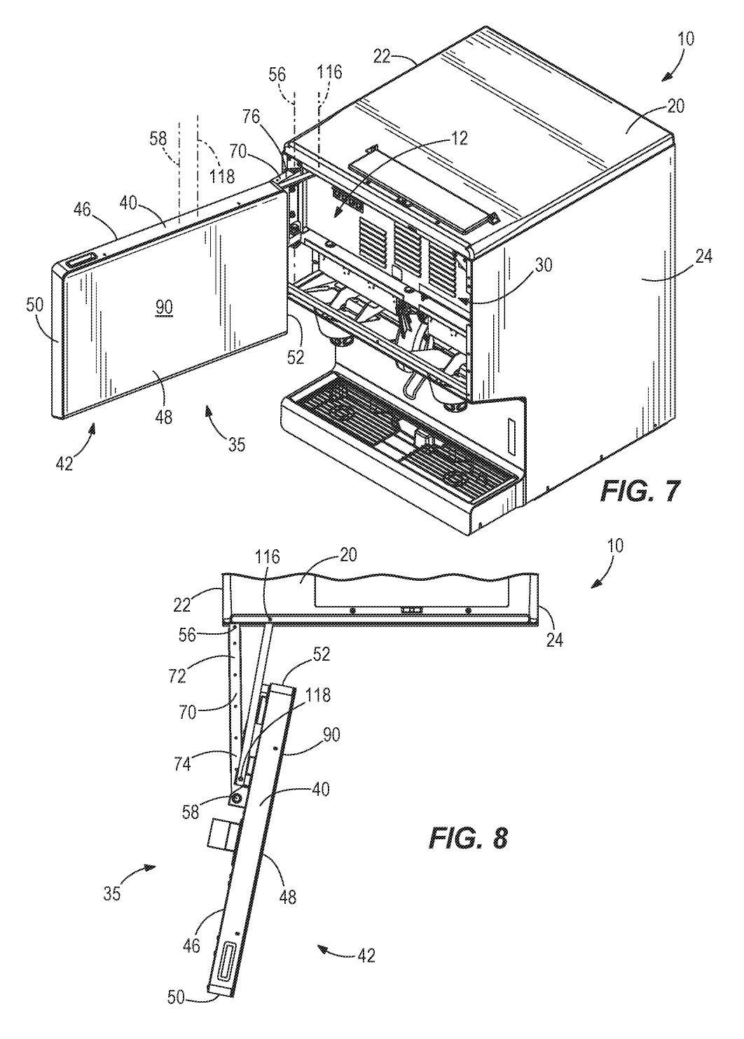

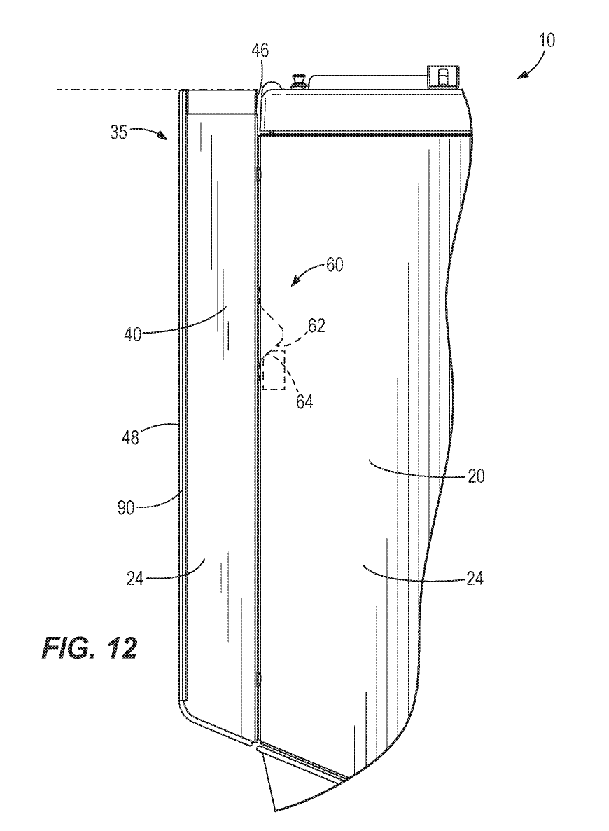

FIGS. 1-12 depict an example beverage dispensing machine 10 that includes a doors apparatus 35 configured to allow an operator to view a display panel 90 while working on beverage dispensing equipment 12 enclosed by a housing 20. The beverage dispensing equipment 12 (see FIG. 7) is accessible to an operator though a service opening 30 after the door apparatus 35 is maneuvered away from the service opening 30.

The housing 20 houses the beverage dispensing equipment 12 for the beverage dispensing machine 10 and defines the service opening 30 through which the beverage dispensing equipment 12 is accessible to an operator (see FIG. 7). The housing 20 has a left side 22 and a right side 24 that are on opposite sides of the service opening 30.

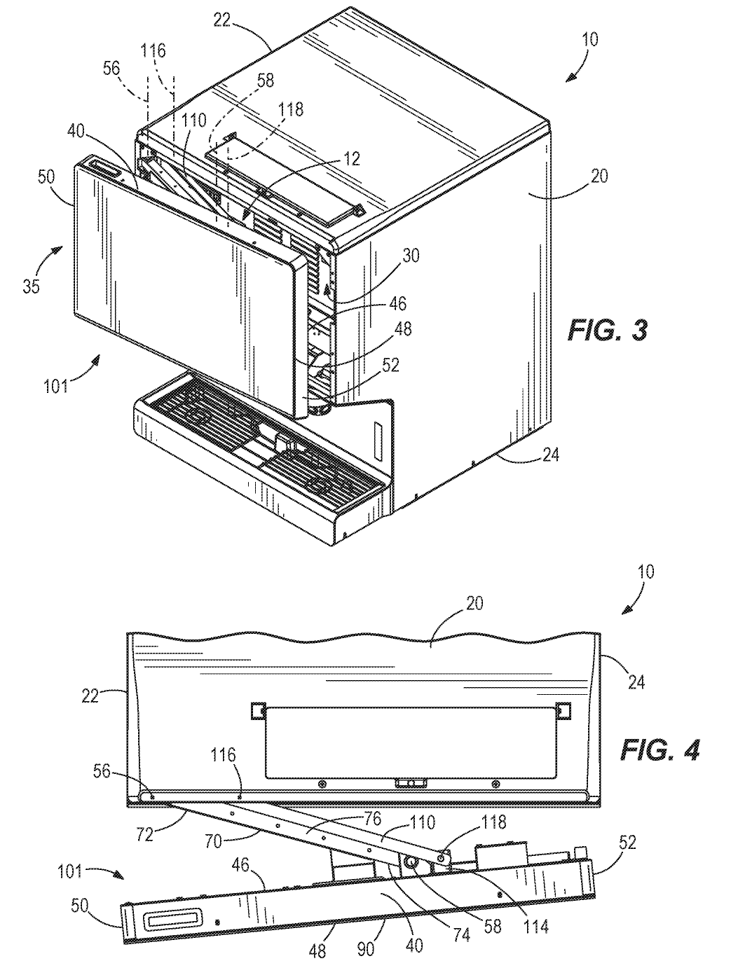

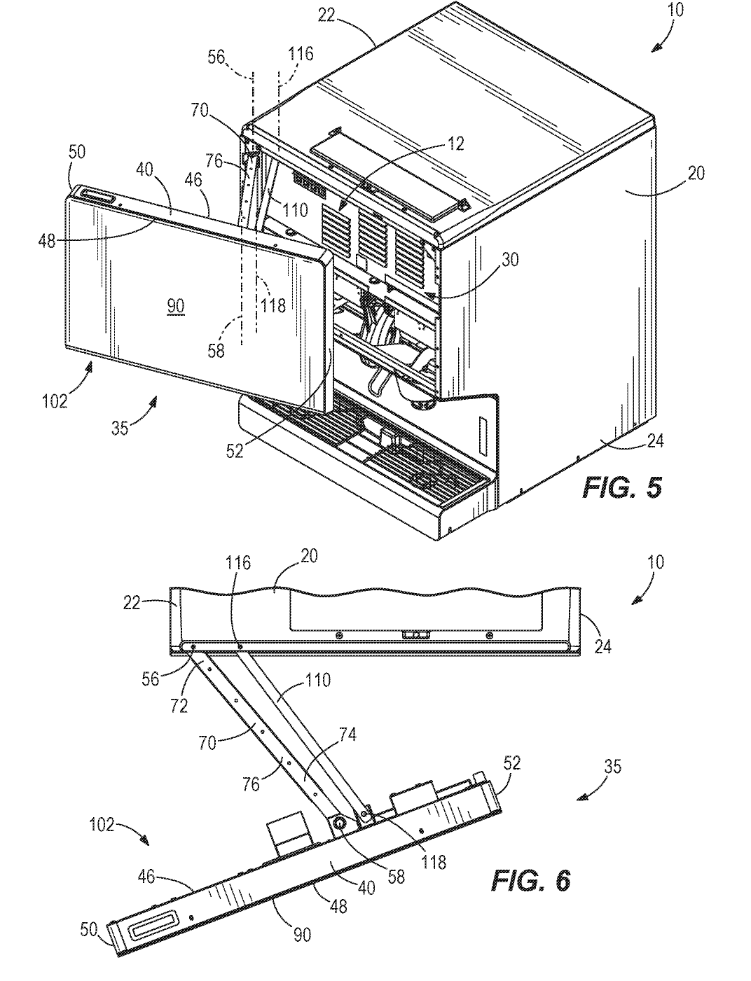

The door apparatus 35 is coupled to the housing 20 and includes a service door 40 and the display panel 90. The service door 40 is movable between an open position 42 (see FIGS. 7 and 8) wherein the beverage dispensing equipment 12 is accessible to an operator via the service opening 30 and a closed position 44 (see FIGS. 1 and 2) wherein the service door 40 closes the service opening 30 so that the beverage dispensing equipment 12 is inaccessible to the operator. As the service door 40 is moved between the open position 42 and the closed position 44, the service door 40 can move into intermediate positions between the open position 42 and the closed position 44 such as a first intermediate position 101 (see FIGS. 3 and 4) and a second intermediate position 102 (see FIGS. 5 and 6). The service door 40 has a left side 50, a right side 52, an inner side 46 that faces the housing 20 when the service door 40 is in the closed position 44, and an outer side 48 that faces away from the housing 20 when the service door 40 is in the closed position 44 (see FIG. 2). The display panel 90 is coupled to the outer side 48 of the service door 40 and is configured to display an operational characteristic of the beverage dispensing equipment 12 to the operator when the service door 40 is in the closed position or open position. The display panel 90 can display any type of operational characteristic such as operating status, maintenance instructions, and/or the like via any suitable type of device such as a video board, a LCD screen, a touch screen, a graphic picture, and/or the like.

When the service door 40 is in the open position 42 the display panel 90 is maneuverable so that the display panel 90 is angled towards the service opening 30. (see FIG. 7). In this position, the operator can view the display panel 90 while accessing the beverage dispensing equipment 12 via the service opening 30. In some examples, the both the service door 40 and the display panel 90 are maneuverable and/or pivotable so that the display panel 90 is angled towards the service opening 30. The service door 40 pivots about a first pivot axis 56 between the open position 42 and the closed position 44. (see FIGS. 3 and 5) When the service door 40 is in the open position 42 (see FIG. 7), the service door 40 and display panel 90 are pivotable about a second pivot axis 58 so that the display panel 90 is angled towards the service opening 30.

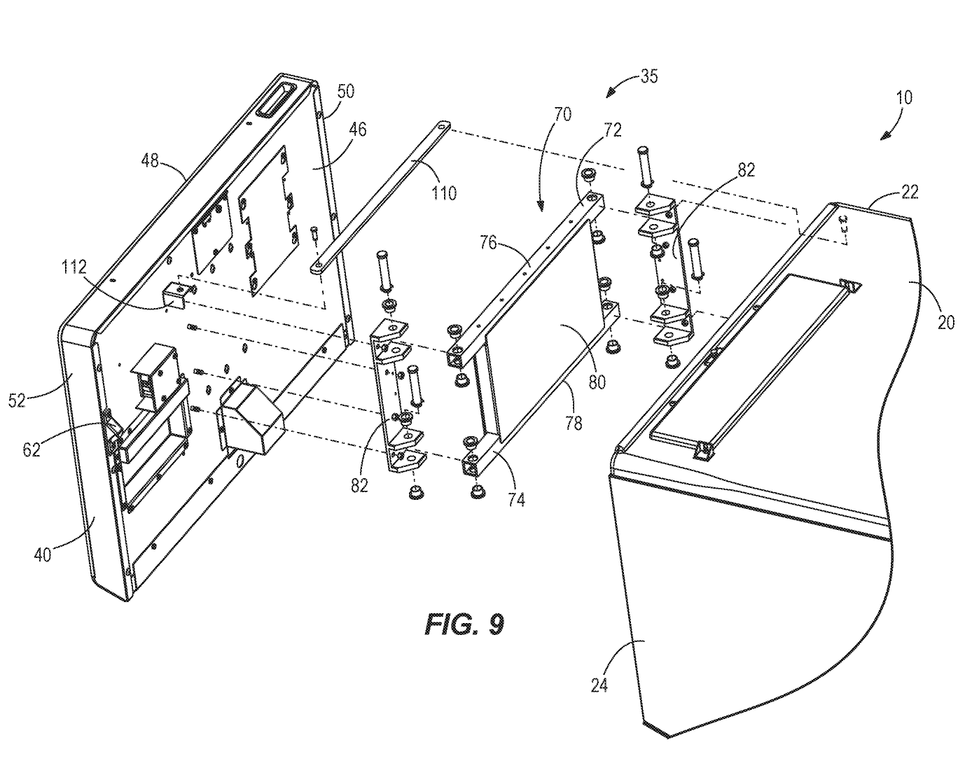

Referring to FIG. 9, the door apparatus 35 includes a pivot arm 70 which couples the service door 40 to the housing 20. (see FIGS. 4 and 6). The pivot arm 70 includes a first end 72 that is coupled to the housing 20 at the first pivot axis 56 and a second end 74 that is coupled the service door 40 at the second pivot axis 58. In some examples, the pivot arm 70 is coupled to the left or right side 22, 24 of the housing 20 so that pivoting of the service door 40 about the first pivot axis 56 from the open position 42 to the closed position 44 completely closes the service opening 30. The pivot arm 70 is coupled to the service door 40 between the left and right sides 50, 52 so that the second pivot axis 58 located between the left and right sides 50, 52.

In the illustrated example, the pivot arm 70 includes an upper support member 76 and a lower support member 78 that each extend between the first and second pivot axes 56, 58. A vertical support plate 80 extends between the upper support member 76 and the lower support member 78, and vertical pivot brackets 82 couple the upper and lower support members 76, 78 to the housing 20 and the service door 40, respectively.

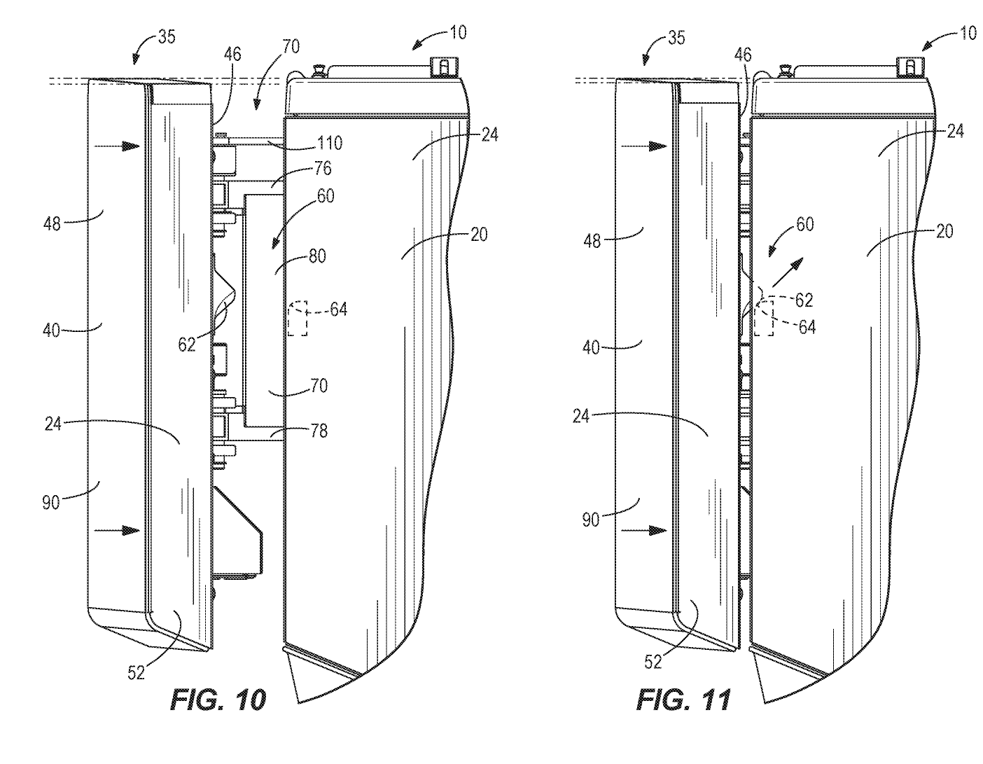

Referring to FIGS. 10-12, a latch 60 latches the service door 40 into the closed position 44. The latch 60 is configured to align the service door 40 with the service opening 30 such that the service door 40 aligns with and closes the service opening 30 despite sag occurring in the pivot arm 70 due to the weight of the door apparatus 35. The latch 60 includes a first camming surface 62 on the service door 40 and a second camming surface 64 on the housing 20 (the second camming surface 64 is depicted in dashed lines; the second camming surface 64 in the example depicted by FIGS. 10-12 is on the inside surface of the housing 20). The first camming surface 62 and second camming surface 64 are curved. When the service door 40 is moved from the open position 42 towards the closed position 44, the first camming surface 62 is cammed upwardly by the second camming surface 64 to squarely align the service door 40 with the service opening 30.

Referring to FIGS. 4, 6, and 8-9, a guide bar 110 pivotaly couples the door apparatus 35 to the housing 20. The guide bar 110 is coupled to the inner side 46 of the service door 40 by a first guide bracket 112 at a third pivot axis 116 and the housing 20 by a second guide bracket (not shown) at a fourth pivot axis 118. The guide bar 50 controls the rotation of the service door 40 and the display panel 90 about the first pivot axis 56 and the second pivot axis 58 as the service door 40 and the display panel 90 move between the open position 42 and the closed position 44. The third pivot axis 116 is offset and parallel to the first pivot axis 56 adjacent to the housing 20, and the fourth pivot axis 118 is offset and parallel to second pivot axis 58 along the inner surface 46 of the service door 40. The guide bar 110 can be disconnected the door apparatus 35 and/or the housing to allow the access panel 20 to freely rotate.

In the present description, certain terms have been used for brevity, clearness and understanding. No unnecessary imitations are to be implied therefrom beyond the requirement of the prior art because such terms are used for descriptive purposes only and are intended to be broadly construed. The different apparatuses described herein may be used alone or in combination with other apparatuses. Various equivalents, alternatives and modifications are possible within the scope of the appended claims.

What is claimed is:

1. A beverage dispensing machine comprising:
a housing that houses beverage dispensing equipment for the beverage dispensing machine, wherein the housing defines a service opening through which the beverage dispensing equipment is accessible to an operator;
a service door on the housing, the service door being movable between an open position wherein the beverage dispensing equipment is accessible to an operator via the service opening and a closed position wherein the service door closes the service opening so that the beverage dispensing equipment is inaccessible to the operator;
wherein the service door has an inner side that faces the housing when the service door is in the closed position and wherein the service door has an outer side that faces away from the housing when the service door is in the closed position; and
a display panel on the outer side of the service door, wherein the display panel is configured to display an operational characteristic of the beverage dispensing equipment to an operator when the service door is in the closed position and when the service door is in the open position;
wherein when the service door is in the open position the display panel is maneuverable so that the display panel is angled towards the service opening so that an operator can view the display panel while accessing the beverage dispensing equipment via the service opening.

2. The beverage dispensing machine according to claim 1, wherein in the open position both the service door and the display panel are maneuverable so that the display panel is angled towards the service opening.

3. The beverage dispensing machine according to claim 1, wherein in the open position both the service door and the display panel are pivotable so that the display panel is angled towards the service opening.

4. The beverage dispensing machine according to claim 3, wherein the service door is pivotable about a first pivot axis between the open position and the closed position and wherein in the open position the service door and display panel are pivotable about a second pivot axis so that the display panel is angled towards the service opening.

5. The beverage dispensing machine according to claim 3, further comprising a pivot arm that couples the service door to the housing, wherein the pivot arm has a first end that is coupled to the housing at the first pivot axis and a second end that is coupled to the service door at the second pivot axis.

6. The beverage dispensing machine according to claim 5, wherein the pivot arm comprises upper and lower support members that extend between the first and second pivot axes.

7. The beverage dispensing machine according to claim 6, wherein the pivot arm further comprises a vertical support plate that extends between the upper and lower support members.

8. The beverage dispensing machine according to claim 7, further comprising vertical pivot brackets that couple the upper and lower support members to the housing and the service door.

9. The beverage dispensing machine according to claim 5, wherein the service door has left and right sides and wherein the pivot arm is coupled to the service door between the left and right sides so that the second pivot axis is located between the left and right sides.

10. The beverage dispensing machine according to claim 9, wherein the housing has left and right sides that are on opposite sides of the service opening, and further wherein the pivot arm is coupled to one of the left and right sides of the housing so that pivoting of the service door about the first pivot axis from the open position to the closed position completely closes the service opening.

11. The beverage dispensing machine according to claim 5, further comprising a latch that latches the service door into the closed position, wherein the latch is configured to align the service door with the service opening such that the service door aligns with and closes the service opening despite sag occurring in the pivot arm.

12. The beverage dispensing machine according to claim 11, wherein the latch comprises a first camming surface on the service door and a second camming surface on the housing, wherein when the service door is moved from the open position towards the closed position, the first camming surface is cammed upwardly by the second camming surface to align the service door with the service opening.

13. The beverage dispensing machine according to claim 12, wherein the first and second camming surfaces are curved.

14. A door apparatus for a beverage dispense machine having a housing that houses beverage dispensing equipment for the beverage dispensing machine, wherein the housing defines a service opening through which the beverage dispensing equipment is accessible to an operator, the door apparatus comprising:
a service door for the housing, the service door being movable between an open position wherein the beverage dispensing equipment is accessible to an operator via the service opening and a closed position wherein the service door closes the service opening so that the beverage dispensing equipment is inaccessible to the operator;
wherein the service door has an inner side that faces the housing when the service door is in the closed position and wherein the service door has an outer side that faces away from the housing when the service door is in the closed position; and
a display panel on the outer side of the service door, wherein the display panel is configured to display an operational characteristic of the beverage dispensing equipment to an operator when the service door is in the closed position and when the service door is in the open position;
wherein when the service door is in the open position the display panel is maneuverable so that the display panel is angled towards the service opening so that an operator can view the display panel while accessing the beverage dispensing equipment via the service opening.

15. The service door according to claim 14, wherein in the open position both the service door and the display panel are maneuverable so that the display panel is angled towards the service opening.

16. The service door according to claim 14, wherein in the open position both the service door and the display panel are pivotable so that the display panel is angled towards the service opening.

17. The service door according to claim 16, wherein the service door is pivotable about a first pivot axis between the open position and the closed position and wherein in the open position the service door and display panel are pivotable about a second pivot axis so that the display panel is angled towards the service opening and further comprising a pivot arm that couples the service door to the housing, wherein the pivot arm has a first end that is coupled to the housing at the first pivot axis and a second end that is coupled to the service door at the second pivot axis.

18. The service door according to claim 17, wherein the service door has left and right sides and wherein the pivot arm is coupled to the service door between the left and right sides so that the second pivot axis is located between the left and right sides, and wherein the housing has left and right sides that are on opposite sides of the service opening, and further wherein the pivot arm is coupled to one of the left and right sides of the housing so that pivoting of the service door about the first pivot axis from the open position to the closed position completely closes the service opening.

19. The service door according to claim 14, further comprising a latch that latches the service door into the closed position, wherein the latch is configured to re-align the service door with the service opening such that the service door squarely aligns with and closes the service opening despite sag occurring in the pivot arm.

20. The service door according to claim 19, wherein the latch comprises a first camming surface on the service door and a second camming surface on the housing, wherein when the service door is moved from the open position towards the closed position, the first camming surface is cammed upwardly by the second camming surface to align the service door with the service opening
